(19) United States
(12) Patent Application Publication
(10) Pub. No.: US 2002/0179169 A1
(43) Pub. Date: Dec. 5, 2002

(54) Disposable sewer hose

(76) Inventor: Donald Y. Shanfelt, Colorado Springs, CO (US)

Correspondence Address: Glen F. Gallinger, 7420 Milner Dr., #1000, Colorado Springs, CO, 80920, US

(21) Appl. No.: 09/871,890

(22) Filed: Jun. 4, 2001

(51) Int. Cl. F16L 11/10

(52) U.S. Cl. 138/129; 138/109; 138/110; 138/96 R

(57) ABSTRACT

This invention provides a solution to the unpleasant and unhygienic chore of cleaning and transporting a reusable sewer hose on a recreational vehicle or cabin trailer. A disposable sewer hose comprises: a compressed spiral member having generally uniform turns which are in direct contact with each other before elongation; and, a plastic sleeve slidably surrounding the spiral member having opposite open ends. When the spiral member is maximally compressed the turns thereof are in direct contact with each other unseparated by the plastic sleeve, thereby facilitating maximal compression and elongation. In a preferred aspect of the invention a tube which is sized to be matably received within a male connector houses the disposable sewer hose before and after use. A flexible strip having opposite end portions has one end portion longitudinally attached to the tube, and the other opposite end portion having a hole therethrough. When the tube is mated within the connector, the hole on the other end of the strip may be positioned over and around a nipple on the connector thereby releasably locking the tube within the connector.

### FIELD OF THE INVENTION

This invention relates to the disposal of waste water and sewage from recreational vehicles and trailers. More particularly this invention relates to a disposable sewer hose which is unexpectedly compact. The unique design of the hose not only facilitates an unexpectedly compact compressed hose, but additionally facilitates the inexpensive manufacture of a fully biodegradable hose.

### BACKGROUND OF THE INVENTION

one of the most unpleasant and unsanitary tasks associated with the ownership and use of a recreational vehicle, hereinafter referred to as an RV, is the disposal of waste water and sewage. The sewage/waste water hose is normally carried in a cavity accessible from a portion of the bumper of an RV. When it is used, it is first removed; then one end portion thereof is connected to a connector extending from a bottom portion of the RV, and the other end portion is fitted with an elbow which is inserted in a drain opening in the ground. After the sewer/waste water is drained from the RV, through the hose into the drain opening, then the dirty hose must be first removed, cleaned, and then replaced within the bumper. Inhalation of the vapors and smelling the stench are unavoidable when handling the dirty hose. Even after the hose has been as thoroughly as possible washed, and stored for carriage in the RV bumper, the unmistakeable odor persists. RV owners afford heavy depreciation, insurance, and fuel costs; they are most able and would be unquestionably willing to afford a minimal additional cost to avoid unquestionably the most unpleasant and unhygienic chore associated with the use of their RV.

The conventional and reusable RV hose comprises a spiralling wire which is covered on both sides with a flexible and resilient plastic. The hose will only minimally longitudinally compress because the flexible and resilient plastic must remain bent and between the turns of the spiralling wire. The wire, like the flexible and resilient plastic are made sufficiently heavy enough to be repeatedly used without replacement. Not only is the hose relatively heavy to lift and manipulate, but it is similarly heavy, and bulky to store and transport. The bumper on the RV must be made substantially larger, and heavier, to accommodate this relatively heavy and bulky hose. A compact and lightweight disposable hose would not only eliminate the unpleasant and unhygienic task of cleaning, but additionally would be easier to manipulate, and actually lower the capital and operational costs of the RV!

### OBJECTS OF THE INVENTION

It is an object of this invention to disclose an improved method of draining the sewage and waste water from an RV. It is an object of this invention to disclose a unique design which facilitates a compact and inexpensive disposable sewer hose for an RV. It is yet a further object of this invention to disclose a design for a waste water/sewer hose which accommodates the construction of a fully biodegradable sewer hose for an RV. It is a final object of this invention to disclose a package for the waste water/sewer hose which can be additionally used as a connector to the conventional waste water connector on an RV, and which finally can be used as a container for the dirty used hose.

One aspect of this invention provides for a disposable sewer hose comprising: a compressed spiral member having generally uniform turns which are in direct contact with each other before elongation; and, a plastic sleeve slidably surrounding the spiral member having opposite open ends. When the spiral member is maximally compressed the turns thereof are in direct contact with each other unseparated by the plastic sleeve, thereby facilitating maximal compression and elongation.

In a preferred aspect of this invention further comprises a tube which houses the compressed sewer hose. The tube is sized to be matably received within a male connector having protruding peripheral nipples. A flexible strip having opposite end portions has one end portion longitudinally attached to the tube, and the other opposite end portion having a hole therethrough. When the tube is mated within the connector, the hole on the other end of the strip may be positioned over and around one of the nipples on the connector thereby releasably locking the tube within the connector.

Various other objects, advantages and features of this invention will become apparent to those skilled in the art from the following description in conjunction with the accompanying drawings.

### FIGURES OF THE INVENTION

FIG. 1 is a partial elevational view of a disposable sewer hose fastened to a waste water/sewer hose connector on a mobile reservoir such as found on an RV or cabin trailer.

FIG. 2 is an enlarged exploded perspective view of the waste water/sewer hose used in FIG. 1.

The following is a discussion and description of the preferred specific embodiments of this invention, such being made with reference to the drawings, wherein the same reference numerals are used to indicate the same or similar parts and/or structure. It should be noted that such discussion and description is not meant to unduly limit the scope of the invention.

### DESCRIPTION OF THE INVENTION

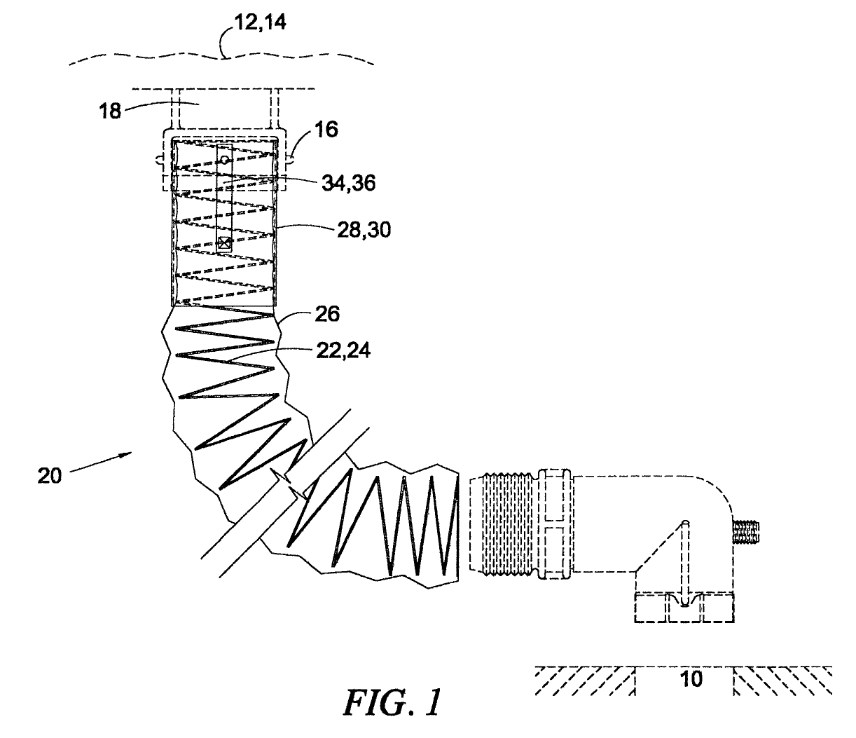

Turning now to the drawings and more particularly to FIG. 1 we have a partial elevational view of a disposable sewer hose 20 fastened to a waste water/sewer hose connector 18 on a mobile reservoir 12 such as found on an RV or cabin trailer. The disposable sewer hose 20 comprises: a compressed spiral member 22 having generally uniform turns 24 which are in direct contact with each other before elongation; and, a plastic sleeve 26 slidably surrounding the spiral member 22 having opposite open ends. When the spiral member 22 is maximally compressed the turns 24 thereof are in direct contact with each other unseparated by the plastic sleeve 26, thereby facilitating maximal compression and elongation.

In a preferred aspect of the invention the hose 20 further comprises an end alignment means 28 for maintaining an end portion of the sleeve 26 peripherally adjacent to and in longitudinal alignment with an end portion of the spiral member 22. Most preferably the end alignment means 28 comprises a tube 30 which additionally houses the compressed spiral member 22 and sleeve 26.

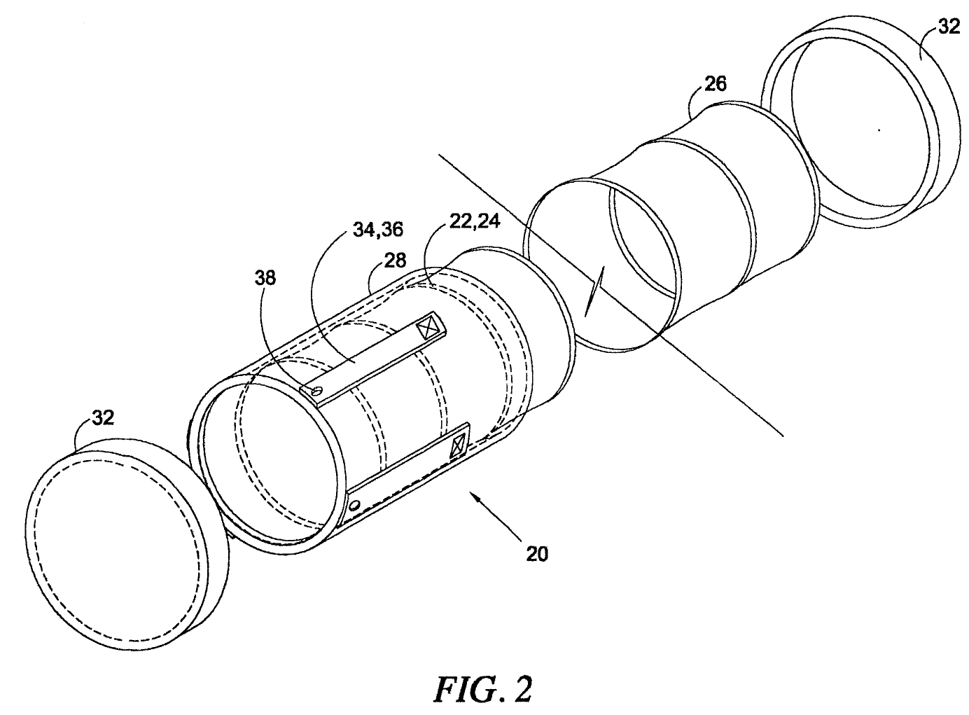

FIG. 2 is an enlarged exploded perspective view the of the waste water/sewer hose 20 used in FIG. 1. Additionally referring to FIG. 2, it can be seen that the hose 20 most preferably further comprises two end caps 32 to maintain the spiral member 20 in a closed position both prior and subsequent to use. In the most preferred embodiment of the invention the spiral member 22, sleeve 26, and end cap 32 are fabricated from a biodegradable plastic. In a preferred embodiment the spiral member 22 is similar to a child's toy known as a SLINKY™ which is a plastic spiral member 22 having turns 24 having a rectangular cross section. The tube 30 is fabricated alternatively from either paper or biodegradable plastic, so the hose 20 may be entirely safely environmentally disposed of.

The hose 20 most preferably is adapted for use with a connector 18 extending from a mobile reservoir 12. Accordingly, an exterior side portion of the tube 30 is sized to matingly fit within the connector 18. A releasable connector lock means 34 extends from the exterior side portion of the tube 30 for releasably interlocking the hose 20 to the connector 18. Usually, the connector 18 is a male connector having protruding peripheral nipples 16. In the most preferred embodiment of the invention, the releasable connector lock means 34 comprises a flexible strip 36 having opposite end portions, one end portion is longitudinally attached to the tube 30, and the other opposite end portion has a hole 38 therethrough. When the tube 30 is mated within the connector 18, the hole 38 on the other end of the strip 36 may be positioned over and around one of the nipples 16 on the connector 18, thereby releasably locking the tube 30 within the connector 18.

A method of draining sewer and waste water 14 through a connector 18 on a mobile reservoir 12 comprises the steps of: connecting one end portion of a compressed spiral member 22 to the connector 18, said spiral member 22 surrounded by an exterior plastic sleeve 26, and said spiral member 22 having turns 24 being in direct contact with each other, unseparated by the plastic sleeve 26 thereby facilitating maximal compression and elongation; and, extending an other end portion the spiral member 22 and the sleeve 26 to approach a drain opening 10. The sewer and waste water 14 may then drain through the spiral member 22 and sleeve 26 to the drain opening 10. Most preferably a tube 30 is provided to house the compressed spiral member 22 and sleeve 26. The tube 30 has a diameter sized to mate within the projecting connector 18 so that the step of inserting the tube 30 within the connector 18 is facilitated.

In a preferred method a releasable connector lock means 34 is provided on an exterior side portion of the tube 30. In the most preferred method the connector 18 further comprises protruding peripheral nipples 16. The releasable connector lock means 34 comprises a flexible plastic strip 36. One end portion of the plastic strip 36 is longitudinally attached to the tube 30, and the other opposite end portion has a hole 38 therethrough. The method further comprises the step of positioning the hole 38 on the other end of the strip 36 over and around one of the nipples 16 on the connector 18 so that the tube 30 is releasably locked within the connector 18.

When an end cap 32 is provided to contain the compressed spiral member 22 and sleeve 26 both prior and subsequent to use. Then accordingly, the further step of removing the end cap 32 prior to extending the other end portion of the hose 20 to the drain opening 10 is required.

While the invention has been described with preferred specific embodiments thereof, it will be understood that this description is intended to illustrate and not to limit the scope of the invention, which is defined by the following claims.

I claim:

1) A disposable sewer hose comprising:
a compressed spiral member having generally uniform turns which are in direct contact with each other before elongation; and,
a plastic sleeve slidably surrounding the spiral member having opposite open ends;
so that when the spiral member is maximally compressed the turns thereof are in direct contact with each other unseparated by the plastic sleeve, thereby facilitating maximal compression and elongation.

2) A hose as in claim 1 further comprising an end alignment means for maintaining an end portion of the sleeve peripherally adjacent to and in longitudinal alignment with an end portion of the spiral member.

3) A hose as in claim 2 wherein the end alignment means comprises a tube which additionally houses the compressed spiral member and sleeve.

4) A hose as in claim 3 further comprising an end cap to maintain the spiral member in a closed position both prior and subsequent to use.

5) A hose as in claim 4 wherein the spiral member, sleeve, and end cap are fabricated from a biodegradable plastic and wherein the tube is fabricated from one of paper and biodegradable plastic, so that after use the spiral member, sleeve, end cap and tube may be safely environmentally disposed of.

6) A hose as in claim 3 adapted for use with a connector extending from a mobile reservoir, wherein an exterior side portion of the tube is sized to matingly fit within the connector.

7) A hose as in claim 6 further comprising a releasable connector lock means extending from the exterior side portion of the tube for releasably interlocking the hose to the connector.

8) A hose as in claim 7 wherein the connector is a male connector having protruding peripheral nipples and wherein the releasable connector lock means comprises a flexible strip having opposite end portions, one end portion longitudinally attached to the tube, and the other opposite end portion having a hole therethrough; so that when the tube is mated within the connector, the hole on the other end of the strip may be positioned over and around one of the nipples on the connector thereby releasably locking the tube within the connector.

9) A method of draining sewer and waste water from a mobile reservoir having a connector extending from the reservoir comprising the steps of:
connecting one end portion of a compressed spiral member to the connector, said spiral member surrounded by an exterior plastic sleeve, and said spiral member having turns being in direct contact with each other, unseparated by the plastic sleeve thereby facilitating maximal compression and elongation; and,
extending an other end portion the spiral member and the sleeve to approach a drain opening;
so that the sewer and waste water may drain through the spiral member and sleeve to the drain opening.

10) A method as in claim 9 further providing the step of providing a tube to house the compressed spiral member and sleeve, said tube having a diameter sized to mate within the projecting connector and further comprising the step of inserting the tube within the connector.

11) A method as in claim 10 further comprising the step of providing a releasable connector lock means on an exterior side portion of the tube.

12) A method as in claim 11 wherein the connector further comprises protruding peripheral nipples and wherein the releasable connector lock means comprises a flexible plastic strip, having one end portion longitudinally attached to the tube, and the other opposite end portion having a hole therethrough; and further comprising the step of positioning the hole on the other end of the strip over and around one of the nipples on the connector, thereby releasably locking the tube within the connector.

13) A method as in claim 11 further providing the step of providing an end cap to contain the compressed spiral and sleeve both prior and subsequent to use, and further comprising the step of removing the end cap prior to extending the other end portion of the hose to the drain opening.
